(19) United States
(12) Patent Application Publication
(10) Pub. No.: US 2012/0074362 A1
(43) Pub. Date: Mar. 29, 2012

(54) CHAIN AND LEVER POST PULLER SYSTEMS

(76) Inventor: Margarito Sanchez, (US)

(21) Appl. No.: 13/239,157

(22) Filed: Sep. 21, 2011

Related U.S. Application Data
(60) Provisional application No. 61/385,619, filed on Sep. 23, 2010.

(51) Int. Cl. E04H 17/26; B23P 17/00

(52) U.S. Cl. 254/30; 29/426.1

(57) ABSTRACT

A chain and lever post puller system for pulling 2 inch by 4 inch stakes from the ground. The apparatus may also pull round posts or tee-posts with a minimum of effort and with no prior digging. The chain and lever post puller system is a first class lever, requires no heavy equipment or hydraulics, and is easily transportable by hand. The puller comprises a vertical column to which the pivot lever is removably connected via a hinge, which also forms the fulcrum for the pivot lever. A first end of a chain is attached opposite the handle to the end of the pivot lever, and a self-tightening post grip is attached to the second end of the chain. A downward force is applied to the first end of the pivot lever when the post grip is attached to a stake to remove the stake via mechanical advantage.

### CROSS-REFERENCE TO RELATED APPLICATION

The present application is related to and claims priority from prior provisional application Ser. No. 61/385,619, filed Sep. 23, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of post pullers and more specifically relates to a chain and lever post puller system.

2. Description of the Related Art

The practice of driving posts into the ground to act as a support for various objects and purposes has long been used by individuals. Posts are sometimes cemented into the ground for stability but most often are simply hard-driven by post pounders such as when constructing range fencing. Highway crews may drive posts into the ground adjacent the highway to support traffic signs, and residential fences may be wire fences with posts driven into the ground to support it. Posts and stakes are driven into the ground for a multitude of purposes: residential fencing; city signage; highway signs; park signs and fencing; construction, etc.

Often, the need for the post that has been driven into the ground changes over time but removal is not always cost effective and often the post will either be left ‘standing’ or cut off at ground level; both potentially causing dangerous situations. Alternately, various methods may be used to pull posts that need to be removed due to the post's interference with construction projects, the eventuality of an injury, or the incompatibility with local environmental ordinances. These methods employed are often dangerous and require the use of a piece of powered equipment designed for a different purpose. When powered equipment, such as a backhoe is used to remove posts, two people are often needed. The ground person usually has to attach a chain and keep the tension while the backhoe moves away to eliminate the chain slack. Many injuries are reported in relation to these tasks. Powered equipment for removing posts can be vehicle mounted and operate hydraulically or utilize some other type of torque multiplying apparatus but generally are very large, heavy, and require a significant investment.

Alternative methods that may be used may be digging down by hand far enough to loosen the post and then pulling out the post by hand, which also can be expensive since it is time-consuming and labor intensive. A solution is needed that is inexpensive, easy and convenient to set up, does not require powered vehicles or equipment, and needs very little storage space when not in use.

Various attempts have been made to solve the above-mentioned problems such as those found in U.S. Pat. Nos. And Pub. Nos. 5,054,744; 4,235,034; 5,794,918; 3,576,311; 2,854,213; and 2006/0231810. This prior art is representative of post pullers. None of the above inventions and patents, taken either singly or in combination, is seen to describe the invention as claimed.

Ideally, a post puller should be convenient in-use and portable, and yet, would operate reliably and be manufactured at a modest expense. Thus, a need exists for a reliable chain and lever post puller system to easily and conveniently pull embedded posts from out of the ground, and to avoid the above-mentioned problems.

### BRIEF SUMMARY OF THE INVENTION

In view of the foregoing disadvantages inherent in the known post puller art, the present invention provides a novel (fulcrum) chain and lever post puller system. The general purpose of the present invention, which will be described subsequently in greater detail, is to provide ease and convenience of use and portability.

A chain and lever post puller system is disclosed herein preferably comprising a vertical column having a top end and a bottom end and a bottom portion pivot hinge, a pivot lever comprising a first end and a second end and a top portion pivot hinge, a chain connector comprising a first end and a second end, and a post grip. The bottom portion pivot hinge is non-removably attached to the top end of the vertical column in preferred embodiments. The vertical column may comprise a reinforcement structure for supporting the downward force on the top portion pivot hinge and the bottom portion pivot hinge to provide durability in-use. The vertical column comprises about 24 inches in height with the bottom portion pivot hinge non-removably attached and the bottom side of the pivot lever near the second end comprises the top portion pivot hinge which is non-removably attached. The pivot lever may be about 6 feet in length for high leverage, and hingedly and removably couples via the top portion pivot hinge and the bottom portion pivot hinge using a pin slidably inserted through the hinge orifices. The hinge forms a fulcrum point for the pivot lever and the first end of the pivot lever comprises a handle for applying downward force. The first end of the chain connector may be removably attached to the second end of the pivot lever and the post grip is removably attached to the second end of the chain connector. The post grip may comprise a self-tightening cam gripper but in some embodiments may comprise a clamp tightened on the stake or post using fasteners.

The chain and lever post puller system is usable to remove a post from hard packed ground when the post grip is removably attached to a post and a downward force is exerted (applied) on the first end of the pivot lever. The chain and lever post puller in essence comprises a jack. The vertical column may further comprise a foot-plate which is perpendicularly oriented to the bottom end of the vertical column and is non-removably attached so as to prevent the vertical column from depressing below ground surface level when in use. The foot-plate is about 4 inches wide by about 4 inches long, but may be larger or smaller in some embodiments as per application. The foot-plate, the vertical column, and the pivot lever may comprise a ferrous metal and the vertical column and the pivot lever may be constructed of square tubing, but in some embodiments may be constructed of cylindrical pipe or other suitable equivalent. The post grip is able to removably grip a partially buried wooden (or other such as metal) 2 inch length by 4 inch width stake (or other size/profile post) for extracting from hard packed soil. The chain connector preferably comprises reinforced ferrous metal links but in other embodiments may use a wire rope with swaged eyelets attached to each end.

The present invention holds significant improvements and serves as a fulcrumed chain and lever post puller system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, chain and lever post puller system, entitled “la Chencha', constructed and operative according to the teachings of the present invention.

FIG. 1 shows a perspective view illustrating an in-use condition of a chain and lever post puller system according to an embodiment of the present invention.

FIG. 2 is another perspective view illustrating the chain and lever post puller system according to an embodiment of the present invention of FIG. 1.

FIG. 3 is an exploded view illustrating separate components (as an assembly) of the chain and lever post puller system according to an embodiment of the present invention of FIGS. 1 and 2.

FIG. 4 is a perspective view illustrating the chain and lever post puller system (indicating the fulcruming means) according to an embodiment of the present invention of FIGS. 1 and 2.

FIG. 5 is a flowchart illustrating a method of use for the chain and lever post puller system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a post pulling device and more particularly to a chain and lever post puller system as used to improve the speed and convenience of pulling posts from the ground.

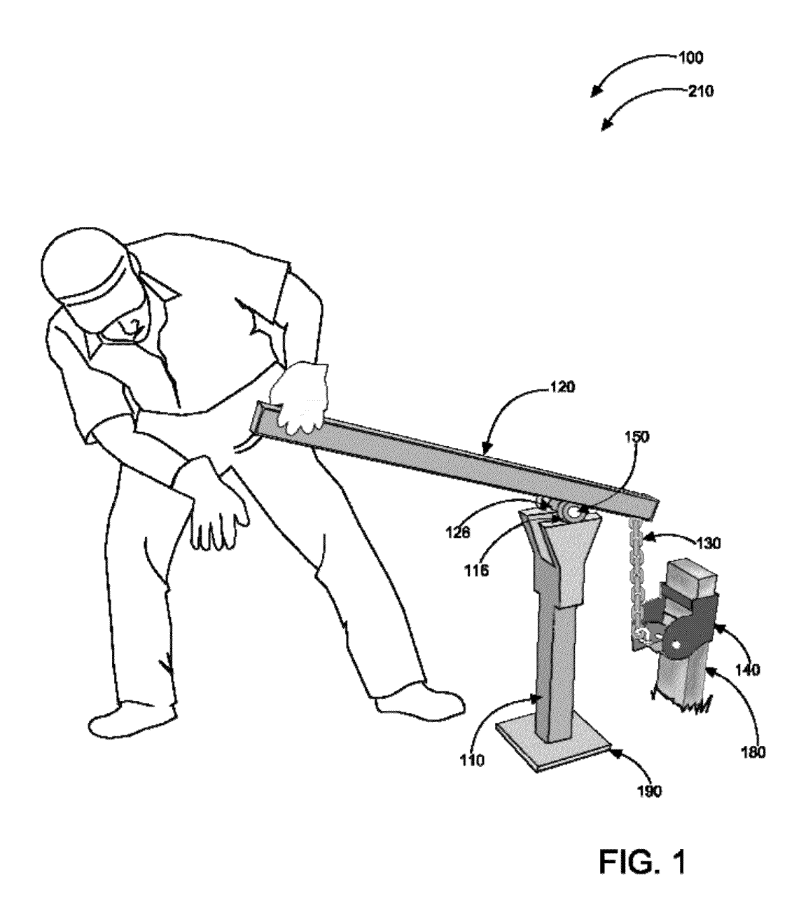

Referring to the drawings by numerals of reference there is shown in FIG. 1, a perspective view illustrating an in-use condition 210 of chain and lever post puller system 100 according to an embodiment of the present invention.

Chain and lever post puller system 100 is a first class lever (in preferred embodiments) preferably comprising vertical column 110 having top end 112 and bottom end 114 and bottom portion pivot hinge 116, pivot lever 120 having first end 122 and second end 124 and top portion pivot hinge 126 (as an assembly). The present invention also preferably comprises chain connector 130 having first end 132 and second end 134, and post grip(per) 140. Bottom portion pivot hinge 116 is preferably non-removably attached to top end 112 of vertical column 110 and top portion pivot hinge 126 is non-removably attached to bottom side of pivot lever 120 near second end 124, creating at least one first class lever fulcruming means.

Vertical column 110 hingedly and removably mates with pivot lever 120 via bottom portion pivot hinge 116 and top portion pivot hinge 126 and is removably coupled via pin 150 (or other suitable fastener.) Bottom portion pivot hinge 116 and top portion pivot hinge 126 form fulcrum point 160 for pivot lever 120; pivot lever 120 provides a mechanical advantage member. First end 132 of chain connector 130 is removably attached to second end 124 of pivot lever 120 and post grip 140 is removably attached to second end 134 of chain connector 130. Chain and lever post puller system 100 is usable to remove post 180 from a hard packed ground when post grip 140 is removably attached to post 180 and a downward force is exerted on first end 122 of pivot lever 120. Post grip 140 is able to removably grip a partially buried metal post for pulling from hard packed soil using the mechanical advantage provided.

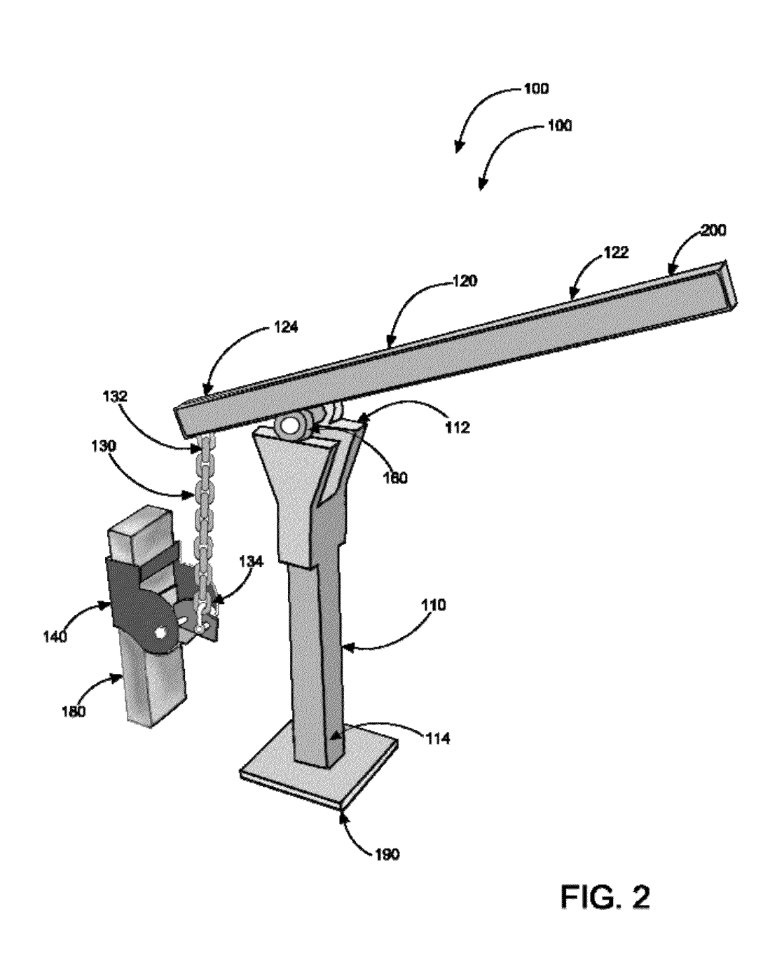

Referring now to FIG. 2, a perspective view illustrating chain and lever post puller system 100 according to an embodiment of the present invention of FIG. 1. Vertical column 110 further comprises foot-plate 190 (also shown in FIGS. 1, 3 and 4) which is preferably perpendicularly oriented to bottom end 114 of vertical column 110 and is non-removably attached thereto and useable to prevent vertical column 110 from depressing below a ground surface (level) when in use. Foot-plate 190 may comprise other angled relationships with vertical column 110 if needed for example if working on inclined surfaces. Foot-plate 190 is about 4 inches wide by about 4 inches long in this particular embodiment and preferably comprises a ferrous metal but in some embodiments may comprise a light-weight non-ferrous metal. Vertical column 110 and pivot lever 120 may comprise a ferrous metal for durability in use, but in alternate embodiments may also comprise a non-ferrous metal for ease of handling (light-weight.) Vertical column 110 and pivot lever 120 preferably comprise square tubing but in other embodiments may comprise cylindrical pipe.

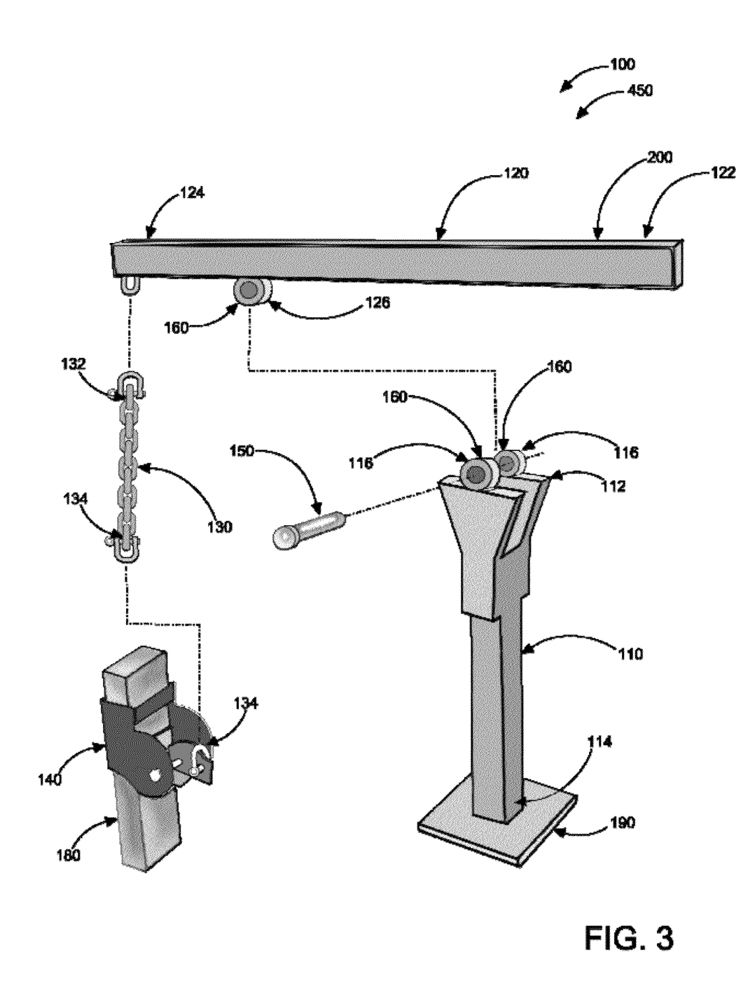

Referring now to FIG. 3, an exploded view illustrating the separate components of chain and lever post puller system 100 (as an assembly) according to an embodiment of the present invention of FIG. 1.

Chain connector 130 preferably comprises reinforced ferrous metal links but in some embodiments may comprise wire rope with swagged eyelets at the ends or other suitable equivalent connecting means. Post grip 140 may comprise a self-tightening cam gripper or may comprise a clamp fastened by bolts or by a biasing spring assisted cam fastener. Those with ordinary skill in the art will now appreciate that upon reading this specification and by their understanding the art of self-tightening cam grippers as described herein, methods of use will be understood by those knowledgeable in such art. First end 122 of pivot lever 120 comprises handle 200 which may be square tubing or may comprise a cylindrical shape. A majority of the length of pivot lever 120 may comprise first end 122, which comprises from fulcrum point 160 to handle 200 end, and a minority of the length of pivot lever 120 may be at second end 124 which is from fulcrum point 160 to end of second end 124. In this way the present invention provides a mechanical advantage using a fulcrum (using a first class lever system.)

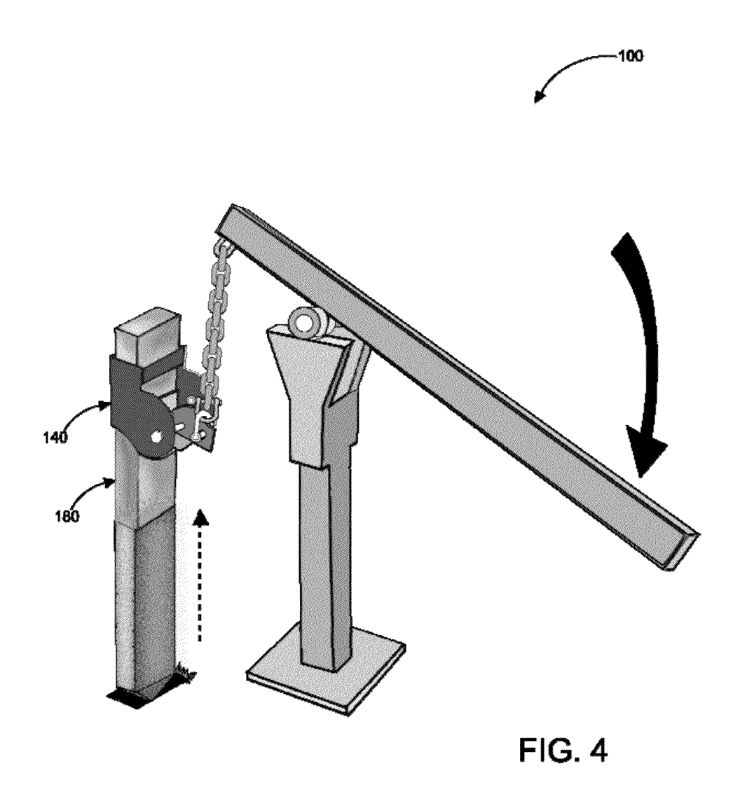

Referring now to FIG. 4, a perspective view (as shown in FIG. 2) illustrating chain and lever post puller system 100 according to an embodiment of the present invention of FIGS. 1 and 2.

Post grip 140 is able to removably grip a partially buried wooden 2 inch length by 4 inch width stake for extracting from hard packed soil (movement as indicated by direction arrow.) Vertical column 110 comprises about 24 inches in height and pivot lever 120 preferably comprises about 6 feet in length providing sufficient mechanical advantage. Chain and lever post puller system 100 in essence comprises a ‘jack’ for applying multiplied lifting force on post 180 at the point of connection of post grip 140. Using the present invention downward rotational force about pin 150 is translated to upward pulling force parallel to vertical column 110 and substantially perpendicularly to the ground surface (and foot-plate 190.)

Chain and lever post puller system 100 according to an embodiment of the present invention of FIGS. 1-4, may be sold as kit 450 comprising the following parts: at least one vertical column 110; at least one pivot lever 120; top portion pivot hinge 126; at least one chain connector 130; at least one post grip 140 (other profiles may be included for cylindrical posts); and at least one set of user instructions. Chain and lever post puller system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, parts may be sold separately, etc., may be sufficient. Additionally, other materials of construction and arrangements such as the use of various metals or alloy(ed) combinations, variations on exact shape, or for example the substitution of wire rope for chain, may be sufficient.

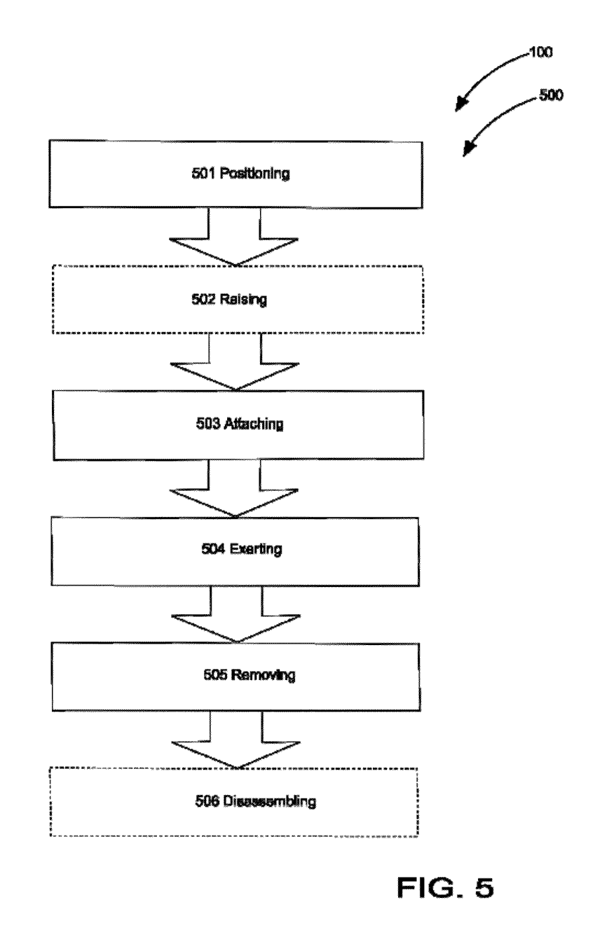

Referring now to FIG. 5, a flowchart illustrating method of use 500 of chain and lever post puller system 100 according to an embodiment of the present invention of FIGS. 1-4.

A method of using chain and lever post puller system 100 may comprise the steps of: step one 501 positioning chain and lever post puller system 100 next (adjacent) to post 180 to be removed; step two 502 raising first end 122 of pivot lever 120 to a ‘high’ (heightened) position; step three 503 attaching post grip 140 to post 180 (and connecting chain connector 130 to post grip 140); step four 504 exerting a downward force on first end 122 of pivot lever 120 to remove post 180; step five 505 removing post grip 140 and chain and lever post puller system 100. Method of using (embodying method of use 500) chain and lever post puller system 100 may further optionally comprise the step of: step six 506 disassembling chain and lever post puller system 100 for compact storage and/or transport.

It should be noted that step 506 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A chain and lever post puller system comprising:
a vertical column comprising:
a top end and a bottom end, and
a bottom portion pivot hinge;
a pivot lever comprising:
a first end and a second end, and
a top portion pivot hinge;
a chain connector comprising;
a first end and a second end; and
a post grip;
wherein said bottom portion pivot hinge is non-removably attached to said top end of said vertical column;
wherein said top portion pivot hinge is non-removably attached to a bottom side of said pivot lever nearest said second end of said pivot lever;
wherein said vertical column hingedly and removably mates with said pivot lever via said bottom portion pivot hinge and said top portion pivot hinge such
that said bottom portion pivot hinge and said top portion pivot hinge are coupled via a pin and form a fulcrum point for said pivot lever;
wherein said first end of said chain connector is removably attached to said second end of said pivot lever;
wherein said post grip is removably attached to said second end of said chain connector; and
wherein said chain and lever post puller system is usable to remove a post from a hard packed ground when said post grip is removably attached to said post and a downward force is exerted on said first end of said pivot lever.

2. The chain and lever post puller system of claim 1 wherein said vertical column further comprises a foot-plate and wherein said foot-plate is perpendicularly oriented to said bottom end of said vertical column and is non-removably attached thereto and is useable to prevent said vertical column from depressing below a ground surface level when in use.

3. The chain and lever post puller system of claim 2 wherein said foot-plate is about 4 inches wide by about 4 inches long.

4. The chain and lever post puller system of claim 3 wherein said foot-plate comprises a ferrous metal.

5. The chain and lever post puller system of claim 1 wherein said vertical column and said pivot lever comprise a ferrous metal.

6. The chain and lever post puller system of claim 5 wherein said vertical column and said pivot lever comprise square tubing.

7. The chain and lever post puller system of claim 5 wherein said vertical column and said pivot lever comprise cylindrical pipe.

8. The chain and lever post puller system of claim 1 wherein said post grip is able to removably grip a partially buried wooden 2 inch length by 4 inch width stake for extracting from said hard packed soil.

9. The chain and lever post puller system of claim 1 wherein said post grip is able to removably grip a partially buried metal said post for pulling from said hard packed soil.

10. The chain and lever post puller system of claim 1 wherein said chain connector comprises ferrous metal links.

11. The chain and lever post puller system of claim 1 wherein said chain connector comprises wire rope.

12. The chain and lever post puller system of claim 1 wherein said vertical column comprises about 24 inches in height.

13. The chain and lever post puller system of claim 1 wherein said pivot lever comprises about 6 feet in length.

14. The chain and lever post puller system of claim 8 wherein said post grip comprises a self-tightening cam gripper.

15. The chain and lever post puller system of claim 1 wherein said first end of said pivot lever comprises a handle.

16. The chain and lever post puller system of claim 1 wherein said chain and lever post puller comprises a jack.

17. A chain and lever post puller system comprising:
a vertical column comprising:
a top end and a bottom end, and
a bottom portion pivot hinge;
a pivot lever comprising:
a first end and a second end, and
a top portion pivot hinge;
a chain connector comprising,
a first end and a second end;
a foot-plate;
a pin; and
a post grip;
wherein said bottom portion pivot hinge is non-removably attached to said top end of said vertical column;
wherein said vertical column comprises about 24 inches in height;
wherein said top portion pivot hinge is non-removably attached to a bottom side of said pivot lever near said second end of said pivot lever;
wherein said pivot lever comprises about 6 feet in length;
wherein said vertical column hingedly and removably mates with said pivot lever via said bottom portion pivot hinge and said top portion pivot hinge such that said bottom portion pivot hinge and said top portion pivot hinge are coupled via said pin and form a fulcrum point for said pivot lever;
wherein said first end of said pivot lever comprises a handle;
wherein said first end of said chain connector is removably attached to said second end of said pivot lever;
wherein said post grip is removably attached to said second end of said chain connector;
wherein said post grip comprises a self-tightening cam gripper;
wherein said chain and lever post puller system is usable to remove a post from a hard packed ground when said post grip is removably attached to said post and a downward force is exerted on said first end of said pivot lever;
wherein said chain and lever post puller comprises a jack;
wherein said vertical column further comprises said foot-plate and wherein said foot-plate is substantially perpendicularly oriented to said bottom end of said vertical column and is non-removably attached thereto and useable to prevent said vertical column from depressing below a ground surface level when in use;
wherein said foot-plate is about 4 inches wide by about 4 inches long;
wherein said foot-plate comprises a ferrous metal;
wherein said vertical column and said pivot lever comprise said ferrous metal;
wherein said vertical column and said pivot lever comprise square tubing and/or cylindrical pipe;
wherein said post grip is able to removably grip a partially buried wooden or metal 2 inch length by 4 inch width stake for extracting from hard packed soil;
wherein said chain connector comprises ferrous metal links or wire rope; and
wherein said chain and lever post puller system is usable to remove said post from a said hard packed ground when said post grip is removably attached to said post and a downward force is exerted on said first end of said pivot lever.

18. A chain and lever post puller system of claim 17 further comprising a kit including:
said at least one said vertical column;
said pivot lever;
at least one said chain connector;
said at least one said post grip; and
a set of user instructions.

19. A method of using a chain and lever post puller system comprising the steps of:
positioning a chain and lever post puller system next to a post to be removed;
raising a first end of a pivot lever to a high position;
attaching a post grip to said post via a chain connector;
exerting a downward force on said first end of said pivot lever to remove said post;
removing said post grip; and
storing said chain and lever post puller system.

20. The method of claim 19 further comprising the step of disassembling said chain and lever post puller system for compact storage.
